(19) United States
(12) Patent Application Publication
(10) Pub. No.: US 2024/0349029 A1
(43) Pub. Date: Oct. 17, 2024

(54) ACCESS POINT DEVICE AND COMMUNICATION CONTROL DEVICE

(71) Applicant: BUFFALO INC., Nagoya-shi (JP)

(72) Inventors: Yuki ISHIKAWA, Aichi (JP); Hidenori YUKAWA, Aichi (JP); Masaya TANIGAWA, Aichi (JP)

(73) Assignee: BUFFALO INC., Nagoya-shi (JP)

(21) Appl. No.: 18/632,276

(22) Filed: Apr. 10, 2024

(30) Foreign Application Priority Data
Apr. 14, 2023 (JP) 2023-066462

(51) Int. Cl. H04W 8/08; H04W 28/06

(52) U.S. Cl. CPC H04W 8/08; H04W 28/065

(57) ABSTRACT

An access point device includes circuitry configured to communicate with a wireless terminal by using at least first and second frequency bands that are different from each other, and receive a data packet destined for the access point device that includes a data packet destined for the wireless terminal. The circuitry of the access point device is also configured to reconstruct the data packet destined for the wireless terminal from the data packet for the access point device that is received, and transmit the data packet destined for the wireless terminal that is reconstructed, to the wireless terminal by using one of the first and second frequency bands.

### CROSS-REFERENCE TO RELATED APPLICATION

This application is based on and claims priority under 35 USC 119 from Japanese Patent Application No. 2023-066462 filed on Apr. 14, 2023, the contents of which are incorporated herein by reference.

### TECHNICAL FIELD

The present disclosure relates to an access point device and a communication control device.

### BACKGROUND

Japanese Patent Application Laid-Open Publication No. 2003-318920 discloses a technology (so-called roaming technology) that, when there is a wireless terminal in an overlap area of cells formed by two access points, determines a connection destination by comparing a “distance” between the wireless terminal and each access point and allows the access point of the connection destination to be selected stably and reliably.

However, in this roaming, when the wireless terminal switches connection between access points, re-authentication processing is required, leading to a temporary communication disconnection time.

An object of the present disclosure is to provide an access point device and a communication control device that can shorten the communication disconnection time concerning the roaming.

### SUMMARY

A first aspect of the present disclosure relates to an access point device including circuitry configured to: communicate with a wireless terminal by using at least first and second frequency bands that are different from each other; receive a data packet destined for the access point device that includes a data packet destined for the wireless terminal; reconstruct the data packet destined for the wireless terminal from the data packet destined for the access point device that is received; and transmit the data packet destined for the wireless terminal that is reconstructed, to the wireless terminal as a destination by using one of the first and second frequency bands.

A second aspect of the present disclosure relates to an access point device including circuitry configured to communicate with a wireless terminal by using at least first and second frequency bands that are different from each other; receive a data packet destined for the wireless terminal or an information processing device on a wide area network; include at least a part of the data packet that is received in a data packet destined for another access point device; and transmit the data packet destined for the another access point to the another access point device.

A third aspect of the present disclosure relates to a communication control device connected to a first access point device and a second access point device each being configured to communicate with a wireless terminal by using at least first and second frequency bands that are different from each other. The communication control device includes circuitry configured to: receive a data packet destined for the wireless terminal; include at least a part of the data packet that is received in a data packet destined for the first access point device; transmit the data packet destined for the first access point device to the first access point device by using one of the first and second frequency bands; include at least a part of the data packet that is received in a data packet destined for the second access point device; and transmit the data packet destined for the second access point device to the second access point device by using the other of the first and second frequency bands.

### BRIEF DESCRIPTION OF DRAWINGS

Exemplary embodiments of the present disclosure will be described in detail based on the following figures, wherein:

FIG. 1 is a block diagram showing a configuration example of a wireless communication system according to an embodiment of the present disclosure;

FIG. 2 is a functional block diagram showing an example of a control unit of an access point device according to the embodiment of the present disclosure;

FIG. 3 is a view illustrating a structure example of a transfer data packet generated in the wireless communication system according to the embodiment of the present disclosure;

FIG. 4 is a flowchart showing an operation example of the wireless communication system according to the embodiment of the present disclosure; and

FIG. 5 is a flowchart showing another operation example of the wireless communication system according to the embodiment of the present disclosure.

### DESCRIPTION OF EMBODIMENTS

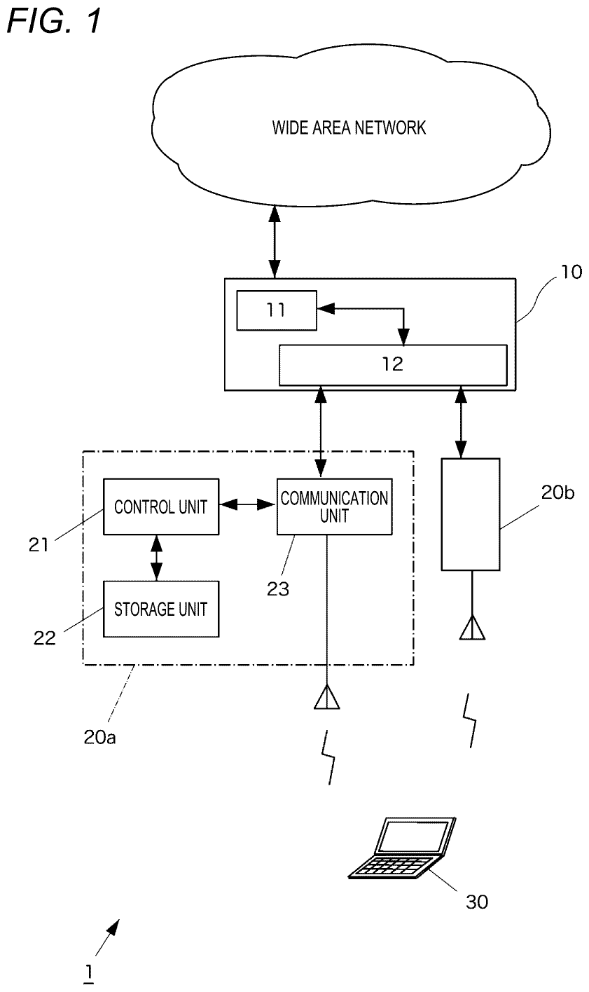

Embodiments of the present disclosure will be described with reference to the drawings. A wireless communication system 1 according to an embodiment of the present disclosure includes a router 10, a first access point device 20a, a second access point device 20b, and a terminal device 30, as illustrated in FIG. 1.

The router 10 implements the communication control device of the present disclosure, is connected to a communication network such as the Internet (hereinafter, referred to as a wide area network), and transmits and receives data (which is generally packetized and thus, is hereinafter referred to as a data packet) to and from other router devices, terminals, and the like connected via the wide area network. In addition, the router 10 includes a control unit 11 including a program control device such as a CPU and a switch unit 12 having a plurality of ports, and each port of the switch unit 12 is communicatively connected to first, second . . . access point devices 20a, 20b . . . (hereinafter, for simple description, it is assumed that the first and second access point devices 20a and 20b are connected).

Here, the control unit 11 of the router 10 controls the following operations in accordance with a program installed in advance in the router 10. Note that the program may be provided with being stored on a computer-readable, non-transitory recording medium and may be installed in the router 10.

The router 10 operates in accordance with the program, receives a data packet transmitted by the terminal device 30 via the first access point device 20a or the second access point device 20b, and transmits the data packet to a destination of the data packet. Additionally, when the router 10 receives a data packet destined for the terminal device 30 from the wide area network side, the router 10 transmits the data packet to any one of the first and second access point devices 20a and 20b with which the terminal device 30 is currently communicating, via the switch unit 12.

The switch unit 12 obtains a MAC (media access control) address of the terminal device 30, which is a destination of the data packet, and manages information for identifying a port of the switch unit 12 to which the access point device 20 of the first and second access point devices 20a and 20b, with which the terminal device 30 is communicating, is connected in association with the MAC address of the terminal device 30, as a MAC address table. Since such an operation is similar to functions of a general network switch and is widely known, the description of detailed operation will be omitted.

Note that when the router 10 receives, from any one of the first and second access point devices 20a and 20b, a notification to the effect that roaming for a certain terminal device 30 has been completed, the router 10 records information for identifying a port of the switch unit 12 to which any one of the first and second access point devices 20a and 20b having issued the notification is connected in the MAC address table in association with the MAC address of the terminal device 30 for which roaming has been completed, and updates the MAC address table.

Thereby, after completion of roaming, it is possible to transmit a data packet destined for the terminal device 30 via the first or second access point device 20a or 20b that has become a destination of roaming.

The access point device 20 (hereinafter, simply referred to as access point device 20 when there is no need to distinguish between the first and second access point devices 20a and 20b) includes a control unit 21, a storage unit 22, and a communication unit 23.

The control unit 21 is a program control device such as a CPU, and operates in accordance with a program stored in the storage unit 22. In an example of the present embodiment, the control unit 21 receives a data packet destined for the terminal device 30 from the router 10, and transmits the data packet to the terminal device 30 wirelessly, similar to a general access point device. Additionally, the control unit 21 receives a data packet transmitted by the terminal device 30 and transmits the same to the router 10.

The control unit 21 further detects whether another access point device 20 different from the corresponding access point device is connected to the communicatively connected router 10 (whether another access point device 20 is connected to a network that allows for broadcasting from the corresponding access point device), and performs roaming processing when another access point device is connected. The operation of the control unit 21 will be described in detail below.

The storage unit 22 is a memory device or the like and maintains a program that is executed by the control unit 21. The program may be provided with being stored on a computer-readable, non-transitory recording medium and may be stored in the storage unit 22.

The communication unit 23 is communicatively connected to the terminal device 30 through wireless communication using at least two different first and second frequency bands. Additionally, the communication unit 23 is communicatively connected to the router 10 in a wired or wireless manner, for example.

The terminal device 30 is an information processing device with a wireless communication function, such as a smart phone or a personal computer (PC). In an example of the present embodiment, the terminal device 30 is communicatively connected to the access point device 20 by wireless communication using at least two different first and second frequency bands (for example, each frequency band of the 2.4 GHz and 5 GHz bands).

In addition, the terminal device 30 determines whether to start roaming, and executes roaming processing when it is decided to start roaming. As an example, the terminal device 30, in a usual state (not during roaming), performs wireless communication with any one access point device 20 by using each of at least two different first and second frequency bands (so-called Multi Link Operation; MLO).

Then, the terminal device 30 obtains information about a signal strength of wireless communication with the access point device 20 that is in communication through the MLO or the access point device 20 that is not in communication, and based on the information about the signal strength, decides whether to start roaming. The conditions for starting the roaming may be similar to those in existing roaming technologies (technologies defined in 802.11k, v, r, and the like).

As an example, the terminal device 30 performs the following processing, assuming that roaming is started when the signal strength of wireless communication with the access point device 20 that is in communication decreases and the signal strength of wireless communication with the access point device 20 (another access point device 20) that is not in communication increases.

That is, when the terminal device 30 decides to start roaming, the terminal device 30 stops wireless communication in some frequency bands (link disconnection), which is performed with the access point device 20 (roaming source) in communication, of wireless communication using a plurality of frequency bands, and starts wireless communication in some frequency bands (link establishment) described above with another access point device 20 (roaming destination). Then, the terminal device 30 requests another access point device 20 that has become a roaming destination to start roaming.

After the start of roaming, when a predetermined condition is satisfied such as the signal strength of wireless communication with the access point device 20 in communication being further lowered and being lowered below the signal strength of wireless communication with another access point device 20 of the roaming destination to which the link has been established, the terminal device 30 disconnects all links to the access point device 20 in communication (i.e., disconnects wireless communication in all frequency bands), and starts wireless communication with another access point device 20 that is a roaming destination by using each of at least two different first and second frequency bands. Thereby, another access point device 20 becomes an access point device 20 in communication and roaming is completed.

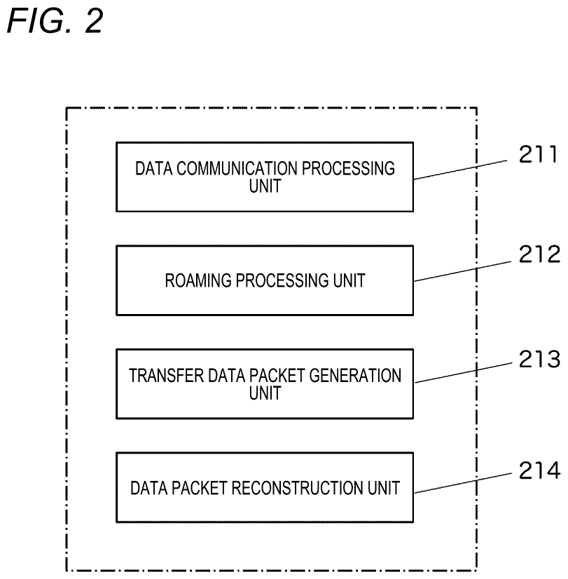

Next, an operation example of the control unit 21 of the access point device 20 of the present embodiment will be described. As illustrated in FIG. 2, the control unit 21 functionally includes a data communication processing unit 211, a roaming processing unit 212, a transfer data packet generation unit 213, and a data packet reconstruction unit 214.

The data communication processing unit 211 transmits and receives data packets to and from the terminal device 30 through wireless communication using at least two different first and second frequency bands.

Specifically, the data communication processing unit 211 receives a data packet destined for the terminal device 30 from the router 10 while the roaming processing unit 212 is not performing roaming processing, and transmits the data packet to the terminal device 30 by wireless communication (MLO) using at least first and second frequency bands, as described above. In addition, during this time, the data communication processing unit 211 receives a data packet transmitted by the terminal device 30 by wireless communication using the at least first and second frequency bands, and transmits the received data packet to the router 10.

Additionally, the data communication processing unit 211 establishes a link for wireless communication in each of the first and second frequency bands and disconnects the link, in response to an instruction from the terminal device 30. As described above, when starting roaming, the terminal device 30 establishes links in different frequency bands and performs wireless communication with each of the plurality of access point devices 20.

When the terminal device 30 requests the start of roaming, the data communication processing unit 211 outputs information to that effect to the roaming processing unit 212 and starts roaming.

When the data communication processing unit 211 of the access point device 20 receives a data packet destined for the terminal device 30 from the router 10 while the roaming processing unit 212 is performing roaming processing, the data communication processing unit 211 outputs at least part of the data packet to the transfer data packet generation unit 213, and transmits at least part of the data packet to the terminal device 30 through wireless communication using a frequency band in which a link is established. Note that the data communication processing unit 211 may allocate a data packet to be output to the transfer data packet generation unit 213 and a data packet to be transmitted to the terminal device 30 through wireless communication among data packets received from the router 10 so that the data packets are not in duplication or so that some data packets are in duplication (i.e., some data packets are duplicated). Additionally, the data communication processing unit 211 may duplicate all data packets received from the router 10, output the data packets to the transfer data packet generation unit 213, and transmit the data packets to the terminal device 30. In this case, all data packets are output to the transfer data packet generator 213 and transmitted to the terminal device 30 in duplication.

Here, the data communication processing unit 211 transmits all data packets destined for the terminal device 30 received from the router 10 so that the data packets are included in at least one of the data packets to be output to the transfer data packet generation unit 213 and the data packets to be transmitted to the terminal device 30. Additionally, regarding which frequency band the terminal device 30 will maintain a link with which access point device 20, a frequency band in which a link is established between the terminal device 30 and the roaming destination during roaming may be determined in advance, or a link in a frequency band with relatively strong strength may be established in wireless communication with the roaming destination based on a predetermined condition such as signal strength between the terminal device 30 and the roaming destination.

In addition, at this time, when the data communication processing unit 211 receives a data packet transmitted by the terminal device 30 through wireless communication using a frequency band in which a link is established among the first, second, . . . , frequency bands, the data communication processing unit 211 transmits the received data packet to the router 10.

Additionally, while the roaming processing unit 212 is performing roaming processing, when a data packet destined for another access point device 20 (hereinafter, for distinction, referred to as a transfer data packet) connected to the router 10 is input from the transfer data packet generating unit 213, the data communication processing unit 211 transmits the data packet to another access point device 20 as a destination via the router 10.

Furthermore, at this time, when the data communication processing unit 211 receives a data packet destined for itself (destined for the access point device 20 itself) from another access point device 20 connected to the router 10, the data communication processing unit 211 outputs the transfer data packet to the data packet reconstruction unit 214, assuming that the data packet destined for itself is a transfer data packet.

Then, when the data packet reconstruction unit 214 outputs a data packet destined for another information processing device connected to the wide area network via the router 10, the data communication processing unit 211 outputs the data packet to the router 10. Additionally, when the data packet reconstruction unit 214 outputs a data packet destined for the terminal device 30, the data communication processing unit 211 transmits the data packet to the terminal device 30 through wireless communication using any one of the first and second frequency bands.

When the roaming processing unit 212 receives, from the data communication processing unit 211, information to the effect that there has been a request to start roaming, the roaming processing unit 212 starts roaming processing and notifies the access point device 20, with which it is connected via the router 10, of the start of roaming by broadcast (simultaneous notification without specifying a destination). The broadcast may use broadcast of a UDP (User Datagram Protocol). Additionally, the notification includes information specifying the terminal device 30 that has made a request to start roaming, such as a MAC address of the terminal device 30.

The roaming processing unit 212, which has received the request to start roaming, also notifies the router 10 and the access point device 20, with which it is connected via the router 10, by broadcast that roaming has been completed, when the terminal device 30, which has made the request to start roaming, establishes a link with the access point device 20 (when roaming ends) including the roaming processing unit 212 in all frequency bands. This broadcast may also use broadcast of a UDP.

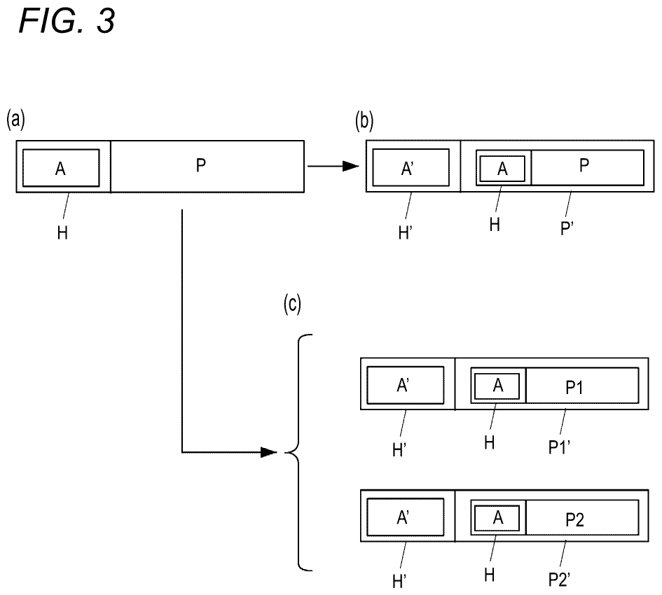

The transfer data packet generation unit 213 duplicates the data packet input from the data communication processing unit 211 and encapsulates it into a transfer data packet destined for the access point device 20 as a roaming destination. Specifically, the data packet that is received from the data communication processing unit 211 by the transfer data packet generation unit 213 includes a header portion H including a MAC address A of an original destination and a payload portion P including user data, as illustrated in FIG. 3A. Here, the original destination is the terminal device 30, an information processing device on a wide area network that can perform communication via the router 10, or the like.

The transfer data packet generation unit 213 generates a new data packet (FIG. 3B) including this data packet in a payload portion P′, attaches a header portion H′ including a MAC address A′ of the access point device 20 as a roaming destination to the payload portion P′ to newly generate a transfer data packet, and outputs the generated transfer data packet to the data communication processing unit 211.

Note that when a size of the data packet input from the data communication processing unit 211 exceeds a size of data that can be included in the payload portion, the data packet input from the data communication processing unit 211 may be divided so that it can be reconstructed later, and may be encapsulated into multiple transfer data packets. As an example, the transfer data packet generation unit 213 extracts the payload portion P of the data packet input from the data communication processing unit 211 and divides the payload portion into a plurality of payload portions P1 and P2. Then, the transfer data packet generation unit 213 attaches a header portion H including the MAC address A of the original destination to each of the payload portions P1 and P2 to construct divided data packets. The transfer data packet generation unit 213 may generate a plurality of new transfer data packets (the payload portion (P) is divided to be equal to or smaller than a size of data that can be included in the payload portion of the transfer data packet) in which the divided data packets are included in the payload portions P1′ and P2′, respectively, and a header portion H′ including the MAC address A′ of the access point device 20 as a roaming destination is attached to each payload portion (FIG. 3C), and output the generated transfer data packets to the data communication processing unit 211.

The data packet reconstruction unit 214 extracts the payload portion P′ from the transfer data packet destined for itself (the access point device 20 itself) received from another access point device 20, takes a data packet included in the payload portion P′, encapsulated into the transfer data packet and destined for the original destination (e.g., terminal device 30, etc.), and output the data packet to the data communication processing unit 211.

### Operations

An example of the wireless communication system 1 of the present embodiment basically has the above-described configuration and operates as follows. Note that in the below, an example will be described in which wireless communication by MLO is initially performed between the first access point device 20a and the terminal device 30, and then the terminal device 30 roams to the second access point device 20b.

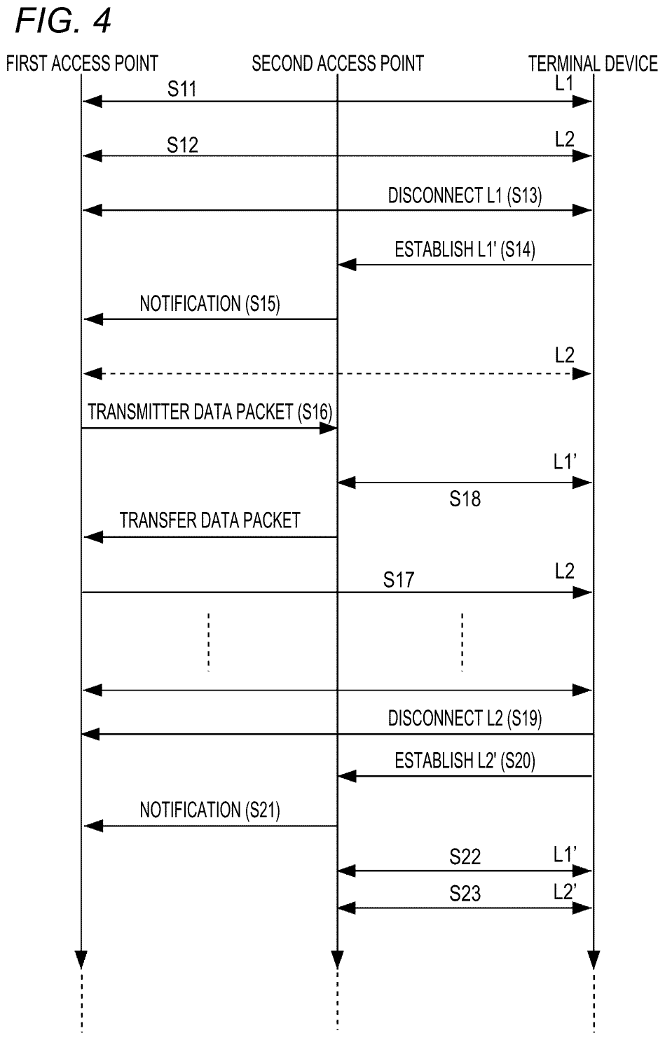

In this example, as illustrated in FIG. 4, it is assumed that the terminal device 30 initially establishes first and second links L1 and L2 in each of a plurality of frequency bands (hereinafter, for simple description, two, i.e., first and second frequency bands) and performs wireless communication with the first access point device 20a (S11, S12).

That is, at this time, when the first access point device 20a receives, from the router 10, data packets D1, D2 . . . destined for the terminal device 30, the first access point device 20a transmits the data packets D1, D2 . . . to the terminal device 30 via the first and second links L1 and L2 established in the first and second frequency bands, respectively. Here, the first access point device 20a may transmit each of the data packets D1, D2 . . . via each of the first and second links L1 and L2. In this case, the terminal device 30 receives each data packet in duplicate via the first and second links L1 and L2.

In another example, the first access point device 20a may sequentially allocate the data packets D1, D2 . . . destined for the terminal device 30 received from the router 10 to one of the first and second links L1 and L2 and transmit the data packets via the allocated links. For example, assuming that the first access point device 20a transmits odd-numbered data packets D1, D3 . . . via the first link L1 and even-numbered data packets D2, D4 . . . via the second link L2, the terminal device 30 receives each data packet via each of the first and second links L1 and L2.

In addition, in steps S11 and S12, the first access point device 20a receives the data packet transmitted by the terminal device 30 via the first and second links L1, L2 corresponding to any one of the first and second frequency bands, and transmits the received data packet to the router 10.

Thereafter, when the terminal device 30 decides to start roaming to the second access point device 20b, the terminal device 30 disconnects the first link L1 in one of the first and second frequency bands, for example, in the first link LI with the first access point device 20a (S13), and requests issuance of a plurality of link IDs corresponding to wireless communication in each frequency band with the second access point device 20b (requests start of roaming). Then, the terminal device 30 first establishes a first link L1′ (corresponding to the link disconnected in step S13) corresponding to the first frequency band with the second access point device 20b (S14). This processing includes authentication processing, but since it is widely known, detailed description is omitted.

During steps S13 to S14, the terminal device 30 continues wireless communication with the first access point device 20a via the second link L2 in the second frequency band.

The second access point device 20b, which has received link establishment, notifies the first access point device 20a, with which it is connected via the router 10, of the start of roaming (S15). This notification includes a MAC address of the second access point device 20b and a MAC address of the terminal device 30 that has requested roaming.

The first access point device 20a receives this notification and starts processing of transferring at least part of the data packets to the second access point device 20b. Additionally, the second access point device 20b starts processing of transferring the data packets received from the terminal device 30 to the first access point device 20a.

That is, the first access point device 20a encapsulates at least part of the data packets destined for the terminal device 30 received from the router 10, for example, a data packet originally intended to be transmitted via the disconnected first link L1 into a data packet destined for the second access point device 20b to form a transfer data packet, and transmits the transfer data packet to the second access point device 20b as a destination (S16).

During this time, the first access point device 20a transmits at least part of data packets received from the router 10, which include at least a data packet not encapsulated into the transfer data packet, of the data packets destined for the terminal device 30 received from the router 10 to the terminal device 30 via the second link L2 (S17).

On the other hand, the second access point device 20b extracts the payload portion of the transfer data packet received from the first access point device 20a, reconstructs the original data packet (encapsulated data packet) from the extracted data, and transmits the reconstructed data packet to the terminal device 30 via the first link L1′ established with the terminal device 30 (S18).

During this time, the data packet destined for the information processing device on the wide area network is transmitted from the terminal device 30 via the second link L2 established with the first access point device 20a or the first link L1′ established with the second access point device 20b. When the first access point device 20a receives this data packet, the first access point device 20a transmits the data packet to the router 10.

On the other hand, the second access point device 20b, which has received the data packet destined for the information processing device on the wide area network from the terminal device 30 via the first link L1′, encapsulates the received data packet into a data packet destined for the first access point device 20a to generate a transfer data packet. Then, the second access point device 20b transmits the generated transfer data packet to the first access point device 20a.

The first access point device 20a extracts the payload portion of the transfer data packet received from the second access point device 20b, reconstructs the original data packet (encapsulated data packet) from the extracted data, and transmits the reconstructed data packet to the router 10.

According to this example of the present embodiment, during the roaming processing, the switch unit 12 of the router 10 does not need to switch the port through which the data packet destined for the terminal device 30 should be transmitted, and has only to output the data packet to the first access point device 20a via the port to which the first access point device 20a is connected continuously from the beginning, and the data packet transmitted from the terminal device 30 is always received from the first access point device 20a. For this reason, the router 10 can communicate with the terminal device 30 through both the first and second access point devices 20a and 20b without updating the MAC address table in the switch unit 20.

Thereafter, assuming that communication with the second access point device 20b is started by the second link L2′ in any one of the first and second frequency bands, in this example, the second frequency band, the terminal device 30 disconnects the second link L2 in the second frequency band with the first access point device 20a (S19), and establishes the second link L2′ in the second frequency band with the second access point device 20b to enable communication (S20).

Accordingly, the second access point device 20b notifies, by UDP broadcast, the router 10 and the access point devices 20 connected with each other via the router 10 of completion of roaming (S21).

At this time, the router 10 records the information identifying the port of the switch unit 12 to which the second access point device 20b is connected in the MAC address table in association with the MAC address of the terminal device 30 for which roaming has been completed, and updates the MAC address table.

Therefore, afterwards, the terminal device 30 establishes the first and second links L1′ and L2′ in each of the first and second frequency bands and performs wireless communication with the second access point device 20b (S22, S23).

That is, at this time, when the second access point device 20b receives a data packet destined for the terminal device 30 from the router 10, the second access point device 20b transmits the data packet to the terminal device 30 via the first and second links L1′ and L2′ established in the first and second frequency bands, respectively.

Since this operation is similar to the operation of the first access point device 20a in steps S11 and S12, repeated description is omitted here.

### Modified Embodiments

In the above description, while the terminal device 30 is roaming, the access point device 20 (of a roaming source) in communication transfers a data packet destined for the terminal device 30 to another access point device 20 (of a roaming destination). However, the present embodiment is not limited to this example, and the router 10 may perform data packet transfer processing.

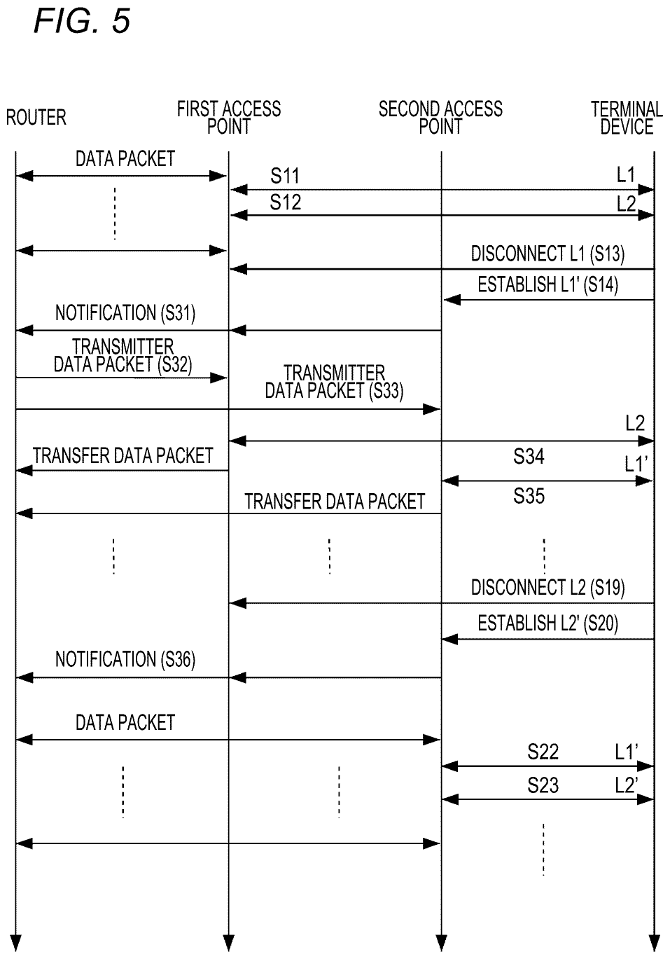

In this example as well, as illustrated in FIG. 5, the terminal device 30 initially establishes the first and second links L1 and L2 in each of the first and second frequency bands and performs wireless communication with the first access point device 20a (S11, S12).

When the terminal device 30 decides to start roaming to the second access point device 20b, the terminal device 30 disconnects the link in any one of the first and second frequency bands with the first access point device 20a, for example, the first link LI in the first frequency band with the first access point device 20a (S13), requests to issue a plurality of link IDs corresponding to the wireless communication paths in the respective frequency bands with the second access point device 20b (requests to start roaming), and first establishes the first link L1′ corresponding to the first frequency band (corresponding to the link disconnected in step S13) with the second access point device 20b (S14).

In this example as well, during steps S13 and S14, the terminal device 30 continues wireless communication with the first access point device 20a via the second link L2 in the second frequency band.

In this example, the second access point device 20b, which has received link establishment, notifies the router 10 of the start of roaming by broadcast (S31). This notification includes a MAC address of the second access point device 20b and a MAC address of the terminal device 30 that has requested roaming.

In this example of the present embodiment, the control unit 11 of the router 10 implements the functions of the transfer data packet generation unit 213 and the data packet reconstruction unit 214 in the access point device 20 in the example described above.

That is, when the router 10 in this example is notified of the start of roaming, the router encapsulates at least part of the data packet destined for the terminal device 30 into a transfer data packet destined for the first access point device 20a. Since this processing is similar to that described as the operation of the transfer data packet generating unit 213, repeated description is omitted.

In addition, the router 10, in this processing, encapsulates, as at least part of the data packet destined for the terminal device 30, a data packet including a data packet not encapsulated into a transfer data packet destined for the first access point device 20a into a transfer data packet destined for the second access point device 20b.

The router 10 transmits a transfer data packet destined for the first access point device 20a to the first access point device 20a (S32), and also transmits a transfer data packet destined for the second access point device 20b to the second access point device 20b (S33). The control unit 11 of the router 10 that performs these processing implements the first transfer unit and the second transfer unit according to one aspect of the present disclosure.

In this example as well, the router 10 may encapsulate and transmit the data packets D1, D2 . . . destined for the terminal device 30 into transfer data packets destined for the first and second access point devices 20a and 20b, respectively. In this example, the terminal device 30 receives each data packet in duplicate via the second link L2 of the first access point device 20a and the first link L1′ of the second access point device 20b.

Additionally, the router 10 may sequentially allocate the data packets D1, D2 . . . destined for the terminal device 30 to any of the first and second access point devices 20a and 20b as destinations, and encapsulate and transmit the data packets into transfer data packets destined for the allocated access point devices 20 as destinations. In this case, the transfer data packet destined for the second access point device 20b includes a data packet that is not included in the transfer data packet destined for the first access point device 20a among the data packets destined for the terminal device 30. As an example, the router 10 may encapsulate and transmit odd-numbered data packets D1, D3 . . . into transfer data packets destined for the first access point device 20a, and encapsulate and transmit even-numbered data packets D2, D4 . . . into transfer data packets destined for the second access point device 20b. In this example, the terminal device 30 receives each data packet via each of the first and second access point devices 20a and 20b.

Then, the first access point device 20a extracts the payload portion of the transfer data packet received from the router 10, reconstructs the original data packet (encapsulated data packet) from the extracted data, and transmits the reconstructed data packet to the terminal device 30 via the second link L2 established with the terminal device 30 (S34).

In addition, the second access point device 20b extracts the payload portion of the transfer data packet received from the router 10, reconstructs the original data packet (encapsulated data packet) from the extracted data, and transmits the reconstructed data packet to the terminal device 30 via the first link L1′ established with the terminal device 30 (S35).

During this time, the data packet destined for the information processing device on the wide area network is transmitted from the terminal device 30 via the second link L2 established with the first access point device 20a or the first link L1′ established with the second access point device 20b. Then, the first access point device 20a encapsulates the data packet received from the terminal device 30 into a transfer data packet destined for the router 10 and transmits the transfer data packet to the router 10 as a destination. Additionally, the second access point device 20b encapsulates the data packet received from the terminal device 30 into a transfer data packet destined for the router 10 and transmits the transfer data packet to the router 10 as a destination.

When the router 10 receives the transfer data packet destined for itself, the router extracts the payload portion, reconstructs the original data packet (encapsulated data packet) from the extracted data, and transmits the reconstructed data packet via the wide area network.

Also in this example of the present embodiment, during the roaming processing, the switch unit 12 on the router 10 side can perform communication with the terminal device 30 via both the first and second access point devices 20a and 20b without switching a port through which the data packet destined for the terminal device 30 should be transmitted.

Thereafter, the terminal device 30 starts communication by the second link L2′ in the second frequency band with the second access point device 20b, which is a link in any one of the first and second frequency bands (in this example, the second link in the second frequency band). Then, the terminal device 30 disconnects the second link L2 in the second frequency band with the first access point device 20a (S19), and establishes the second link L2′ in the second frequency band with the second access point device 20b to enable communication (S20).

Accordingly, the second access point 20b notifies, by UDP broadcast, the router 10 and the access point devices 20 connected with each other via the router 10 of completion of roaming (S36).

Then, the router 10 records the information identifying the port of the switch unit 12 to which the second access point device 20b is connected in the MAC address table in association with the MAC address of the terminal device 30 for which roaming has been completed, and updates the MAC address table.

Therefore, afterwards, the router 10 will transmit a data packet destined for the terminal device 30 only to the second access point device 20b as usual (without encapsulating the data packet as a transfer data packet), and the terminal device 30 will establish the first and second links L1′ and L2′ in each of the first and second frequency bands and perform wireless communication with the second access point device 20b (S22, S23).

### Effects of Embodiment

According to the present embodiment, even during roaming processing such as re-authentication, data packets can be transmitted and received via the access point device of a roaming source or roaming destination, and therefore, communication disconnection time can be shortened. In addition, during this time, communication destined for one terminal device is enabled via a plurality of access point devices, without frequently updating the MAC address table and the like in the switch device on the router side.

The present embodiment described above can be summarized as follows.

One aspect of an access point device of the present disclosure includes circuitry configured to: communicate with a wireless terminal by using at least first and second frequency bands that are different from each other; receive a data packet destined for the access point device that includes a data packet destined for the wireless terminal; reconstruct the data packet destined for the wireless terminal from the data packet destined for the access point device that is received; and transmit the data packet destined for the wireless terminal that is reconstructed, to the wireless terminal as a destination by using one of the first and second frequency bands.

In this example, even during roaming processing, data packets can be transmitted and received to and from a terminal device via the access point device of a roaming source or roaming destination, and therefore, communication disconnection time can be shortened.

The circuitry may further be configured to start receiving the data packet destined for the access point device that includes the data packet destined for the wireless terminal, after establishing a communication path with the wireless terminal using the one of the first and second frequency bands, and establish a communication path with the wireless terminal, using the other of the first and second frequency bands while performing communication using the one of the first and second frequency bands.

Thereby, roaming processing can be continued while transmitting and receiving data packets between the terminal device and the access point device of a roaming source or roaming destination, and therefore, communication disconnection time related to roaming can be shortened.

Another aspect of an access point device of the present disclosure includes circuitry configured to: communicate with a wireless terminal by using at least first and second frequency bands that are different from each other; receive a data packet destined for an information processing device on a wide area network or the wireless terminal; include at least a part of the data packet that is received in a data packet destined for another access point device; and transmit the data packet destined for the another access point to the another access point device.

Thereby, even during roaming processing, data packets can be transmitted and received to and from the terminal device via the access point device of a roaming source or roaming destination, and therefore, communication disconnection time can be shortened.

The circuitry may further be configured to: receive information on a destination address of the another access point device from the another access point device; include at least a part of the data packet that is received in the data packet destined for the another access point device; and transmit the data packet destined for the another access point to the destination address of the another access point device.

The circuitry may further be configured to: start transmission of the data packet to the another access point device after the circuitry is notified of start of roaming from the another access point device.

The circuitry may further be configured to: receive a notification of end of the roaming from the another access point that has established both a communication path using the first frequency band and a communication path using the second frequency band.

Data transmitted to the wireless terminal through a communication path using the first frequency band and data transmitted to the wireless terminal through a communication path using the second frequency band may be the same.

Data transmitted to the wireless terminal through a communication path using the first frequency band and data transmitted to the wireless terminal through a communication path using the second frequency band may be different from each other.

Another aspect of an communication control device of the present disclosure, which is connected to a first access point device and a second access point device each being configured to communicate with a wireless terminal by using at least first and second frequency bands that are different from each other, the communication control device including circuitry configured to: receive a data packet destined for the wireless terminal; include at least a part of the data packet that is received in a data packet destined for the first access point device; transmit the data packet destined for the first access point device to the first access point device by using one of the first and second frequency bands; include at least a part of the data packet that is received in a data packet destined for the second access point device; and transmit the data packet destined for the second access point device to the second access point device by using the other of the first and second frequency bands.

Thereby, even during roaming processing, data packets can be transmitted and received to and from the terminal device via the access point device of a roaming source or roaming destination, and therefore, communication disconnection time can be shortened.

The data packet destined for the second access point device may include a part of the data packet which part is not included in the data packet destined for the first access point device.

The circuitry may further be configured to start transmission of the data packet to the first access point device after roaming is started and a communication path is established between the first access point device and the wireless terminal, and start transmission of the data packet to the second access point device after the roaming is started and a communication path is established between the second access point device and the wireless terminal.

The circuitry may further be configured to terminate the transmission of the data packet to the first access point device after the roaming is terminated and a communication path is not established between the first access point device and the wireless terminal, and terminate the transmission of the data packet to the second access point device after the roaming is terminated and a communication path is not established between the second access point device and the wireless terminal.

The circuitry may further be configured to receive a data packet destined for the communication control device from the first access point device or the second access point device, reconstruct a data packet destined for an information processing device on a wide area network from the data packet destined for the communication control device, and transmit the data packet destined for the information processing device via the wide area network.

Data transmitted to the first access point device using the first frequency band and data transmitted to the second access point device using the second frequency band are the same.

The circuitry may further be configured to receive a request for roaming from the wireless terminal; establish a communication path with the wireless terminal, using the one of the first and second frequency bands, after receiving the request for roaming; and notify another access point device of start of the roaming and receive the data packet destined for the access point device from the another access point device.

The circuitry may further be configured to receive from the wireless terminal a data packet destined for an information processing device on a wide area network, after establishing the communication path with the wireless terminal; include the data packet destined for the information processing device on the wide area network in a data packet destined for the another access point device; and transmit the data packet destined for the another access point device to the another access point device.

The circuitry may further be configured to establish another communication path with the wireless terminal, using the other of the first and second frequency bands, and notify the another access point device of end of the roaming.

According to the present disclosure, even during roaming processing, data packets can be transmitted and received to and from the terminal device via the access point device of a roaming source or roaming destination, and therefore, communication disconnection time can be shortened.

1. An access point device comprising:
circuitry configured to:
communicate with a wireless terminal by using at least first and second frequency bands that are different from each other;
receive a data packet destined for the access point device that includes a data packet destined for the wireless terminal;
reconstruct the data packet destined for the wireless terminal from the data packet destined for the access point device that is received; and
transmit the data packet destined for the wireless terminal that is reconstructed, to the wireless terminal as a destination by using one of the first and second frequency bands.

2. The access point device according to claim 1, wherein
the circuitry is further configured to
start receiving the data packet destined for the access point device that includes the data packet destined for the wireless terminal, after establishing a communication path with the wireless terminal using the one of the first and second frequency bands, and
establish a communication path with the wireless terminal, using the other of the first and second frequency bands while performing communication using the one of the first and second frequency bands.

3. An access point device comprising:
circuitry configured to:
communicate with a wireless terminal by using at least first and second frequency bands that are different from each other;
receive a data packet destined for an information processing device on a wide area network or the wireless terminal;
include at least a part of the data packet that is received in a data packet destined for another access point device; and
transmit the data packet destined for the another access point to the another access point device.

4. The access point device according to claim 3, wherein
the circuitry is further configured to:
receive information on a destination address of the another access point device from the another access point device;
include at least a part of the data packet that is received in the data packet destined for the another access point device; and
transmit the data packet destined for the another access point to the destination address of the another access point device.

5. The access point device according to claim 3, wherein
the circuitry is further configured to
start transmission of the data packet to the another access point device after the circuitry is notified of start of roaming from the another access point device.

6. The access point device according to claim 4, wherein
the circuitry is further configured to
receive a notification of end of the roaming from the another access point that has established both a communication path using the first frequency band and a communication path using the second frequency band.

7. The access point device according to claim 3, wherein
data transmitted to the wireless terminal through a communication path using the first frequency band and data transmitted to the wireless terminal through a communication path using the second frequency band are the same.

8. The access point device according to claim 3, wherein
data transmitted to the wireless terminal through a communication path using the first frequency band and data transmitted to the wireless terminal through a communication path using the second frequency band are different from each other.

9. A communication control device connected to a first access point device and a second access point device each being configured to communicate with a wireless terminal by using at least first and second frequency bands that are different from each other, the communication control device comprising:
circuitry configured to;
receive a data packet destined for the wireless terminal;
include at least a part of the data packet that is received in a data packet destined for the first access point device;
transmit the data packet destined for the first access point device to the first access point device by using one of the first and second frequency bands;
include at least a part of the data packet that is received in a data packet destined for the second access point device; and
transmit the data packet destined for the second access point device to the second access point device by using the other of the first and second frequency bands.

10. The communication control device according to claim 9, wherein
the data packet destined for the second access point device includes a part of the data packet which part is not included in the data packet destined for the first access point device.

11. The access point device according to claim 9, wherein
the circuitry is further configured to
start transmission of the data packet to the first access point device after roaming is started and a communication path is established between the first access point device and the wireless terminal, and
start transmission of the data packet to the second access point device after the roaming is started and a communication path is established between the second access point device and the wireless terminal.

12. The communication control device according to claim 11, wherein
the circuitry is further configured to
terminate the transmission of the data packet to the first access point device after the roaming is terminated and a communication path is not established between the first access point device and the wireless terminal, and
terminate the transmission of the data packet to the second access point device after the roaming is terminated and a communication path is not established between the second access point device and the wireless terminal.

13. The communication control device according to claim 9, wherein
the circuitry is further configured to
receive a data packet destined for the communication control device from the first access point device or the second access point device,
reconstruct a data packet destined for an information processing device on a wide area network from the data packet destined for the communication control device, and
transmit the data packet destined for the information processing device via the wide area network.

14. The communication control device according to claim 9, wherein
data transmitted to the first access point device using the first frequency band and data transmitted to the second access point device using the second frequency band are the same.

15. The access point device according to claim 1, wherein
the circuitry is further configured to:
receive a request for roaming from the wireless terminal;
establish a communication path with the wireless terminal, using the one of the first and second frequency bands, after receiving the request for roaming; and
notify another access point device of start of the roaming and receive the data packet destined for the access point device from the another access point device.

16. The access point device according to claim 15, wherein
the circuitry is further configured to
receive from the wireless terminal a data packet destined for an information processing device on a wide area network, after establishing the communication path with the wireless terminal;
include the data packet destined for the information processing device on the wide area network in a data packet destined for the another access point device; and
transmit the data packet destined for the another access point device to the another access point device.

17. The access point device according to claim 15, wherein
the circuitry is further configured to
establish another communication path with the wireless terminal, using the other of the first and second frequency bands, and
notify the another access point device of end of the roaming.
